(19) United States
(12) Patent Application Publication
(10) Pub. No.: US 2009/0222334 A1
(43) Pub. Date: Sep. 3, 2009

(54) Recyclable Protective Barrier for Use in Advertising

(76) Inventors: Lee A. Shepherd, Norfolk, VA (US); John M. Shepherd, Norfolk, VA (US)

Correspondence Address: JOY L BRYANT, P.C., P O BOX 620, LIGHTFOOT, VA, 23090-0620, US

(21) Appl. No.: 12/040,537

(22) Filed: Feb. 29, 2008

(51) Int. Cl. G06Q 30/00; G09F 23/00

(52) U.S. Cl. 705/14; 40/584

(57) ABSTRACT

A recyclable protective barrier for use in advertising is presented. The barrier comprises a single sheet of semi-rigid, recyclable, high density polyethylene fibrous web sheeting pre-cut to cover at least one surface of an article. The sheet has at least one tab extending therefrom and at least one slot for receiving the tab. The sheet has at least one surface capable of receiving at least one kind of permanent ink and a portion of this surface has printing thereon. The sheet is secured to at least one portion of the article by inserting the tab into the slot, forming a physical barrier between at least one portion of the article and a person and wherein the printing is visible to the person.

### FIELD OF THE INVENTION

The present invention is related to protective barriers for articles. In particular, it relates to recyclable protective barriers that are used for advertising and for keeping a person from making direct contact with an article.

### BACKGROUND OF THE INVENTION

Advertising is found nearly everywhere and in many forms. With the advances that have been made in printing technology, practically any item may be imprinted and advertisers are finding that print advertising is an excellent way to inform the public about various products. There are many ways to imprint articles, using processes such as ink-jet printing, silk-screen printing, lithography, and off-set printing with 4-color processing. However, not all of these processes or the inks used in these processes are suitable for all applications or all articles of manufacture. In particular, in applications where the article is subjected to heat, moisture, or combinations of heat and moisture, it has been found that water-soluble inks, such as those used in ink-jet printing, are not suitable because the ink is easily removed. Alternatively, the surface of the article that is to be imprinted will also be a determining factor in the process and the inks used to imprint the article. This is of particular concern when the article will be in contact with human skin.

More recently, there has been a heightened awareness and concern about articles coming into contact with human skin. Recent outbreaks of staph infections have caused the general public to be more aware and concerned with the communicability of disease. Various methods to prevent the spread of communicable diseases have been seen in common public areas such as shopping malls, public restrooms, and grocery stores. One method commonly employed in grocery stores is the provision of sanitary wipes to customers. Customers typically use the wipes to wipe their own hands and the handle of the shopping cart but fail to realize that residual germs may be found in the seat area of the cart. Patrons who utilize public transportation are subject to the possibility of infection transmitted by sitting in a seat or holding a handrail which was previously touched by an infected person. Alternatively, customers who ride on trains, buses, or fly on airplanes and use the seat trays are also subjected to residual bacteria found on the trays which have not been cleaned or have been inadequately cleaned. These are merely a few examples of how germs are transmitted throughout the general public. The provision of antibacterial wipes is only effective if the article is completely wiped down. More recently, it has been found that these wipes are not effective against all forms of bacteria and, in some instances, causes the user to become more susceptible to germ exposure. In other cases, the user's skin is sensitized to the chemicals in the wipes causing rashes or other skin problems. Therefore, it is desirable to provide a physical barrier which may be used to cover the various surfaces that may come into skin contact.

Many different methods have been proposed to solve the problem of germ transmission from shopping carts. Pettigrew et al. (U.S. Pat. No. 6,869,085) describe a cart grip sanitary cover for providing a sanitary surface to be gripped by a user. The cover has multiple layers which are stacked with each layer adhering to the layer below. The bottom layer is attached to a grip of a cart. In use, the topmost layer is removed to expose another sanitary layer underneath. However, the success of the sanitary protection is dependent upon removal of the prior-used layer by the prior-user. If the prior-user does not remove the sanitary cover, then the new user remains exposed or increases exposure when removing the old sanitary cover. In addition, the sanitary covers are not recyclable. Tyree (U.S. Pat. No. 6,543,794) describes a shopping cart sanitary handle cover prepared from a first semi-flexible sheet of a vinyl construction and second sheet of fabric superimposed thereon and heat bonded thereto. The cover is wrapped about a shopping, cart handle or stroller restraining bar and secured in place using circular hook and loop fasteners. The cover is removed after use and washed and re-used. However, not all users will wash the cover between uses (or as they go from store to store on a normal shopping day), therefore, the spread of infectious diseases is increased as the cover is transferred from shopping cart to shopping cart. Neither one of these references addresses the problem of sanitizing the seat or the basket of the shopping cart.

Hunter et al. (US Patent Application Publication No. US2007/0215255A1) describe a disposable sanitary seat cover for use in high chairs and shopping carts. The seat cover includes a seat portion and an optional flap portion depending from the seat portion. The flap portion may include one or more removable sections onto which coupons or other useful consumer information may be printed. The seat portion includes a plurality of passages that permit objects (such as a child's legs and a seat belt) to pass through the plane of the base sheet. The passages may be implemented as perforations that permit the user to create an aperture in the base sheet or may be formed in the sheet during the manufacturing process. The cover is secured to the shopping cart, high chair, or other underlying structure using various means such as passageways in the seat portion which “hook” onto corners of a shopping cart seat or a high chair; an elastic band; or adhesive strips that adhere to the underlying seat. Printing processes for web-based manufacturing such as latex printing on fabrics, ink-jet printing processes, and lithographic printing processes are used to print information on the seat cover. However, the inks used in these processes are typically not water-resistant and will come off on skin in the presence of moisture, such as sweat.

Landine (U.S. Pat. No. 6,517,155B1) describes a disposable shopping cart seat liner for use in protecting a shopping cart and its contents from contamination from a child seated therein. A vessel which is open at a top lip allows a child to be seated therein, and is capable of folding flat prior to use. Pre-scored leg cutouts are on the front panel to create leg openings for the child. The shopping cart liner is made of a thin, foldable, moisture proof material such as poly-coated wrapping paper. The shopping cart seat liner is unfolded in a similar manner that a shopping bag is unfolded, and simply placed within the shopping cart seat. A horizontal flap portion and a downturned flap portion form a flap that may be used to hold the liner in place while it is unfolded. Once unfolded, the flap extends over the shopping cart foldable wall.

Haller (US Patent Application Publication No. 2004/0130193A1) describes a disposable automotive seat cover that is fabricated of a non-woven polyolefin fabric, TYVEK, and is adapted for universal temporary attachment to either a bucket or bench type automotive seat. The attachment is by means of conventional straps, hooks, or an elastic hem.

An object of the present invention is to provide a recyclable, self-securing, protective barrier that may be placed between an article and a person where the barrier has advertising printed thereon.

Another object of the present invention is to provide a recyclable protective barrier prepared from a single sheet of semi-rigid, recyclable, high density polyethylene fibrous web sheeting.

Another object of the present invention is to provide a method for advertising using a recyclable protective barrier.

### SUMMARY OF THE INVENTION

The present invention is for a recyclable protective barrier which serves a dual purpose. First, the barrier acts as a physical barrier between a surface of an article and a person. Secondly, the barrier is used for advertising purposes. In general, the recyclable protective barrier is formed from a single sheet of semi-rigid, recyclable, high density polyethylene fibrous web sheeting. The sheet is pre-cut to cover at least one surface of an article. The sheet has at least one tab extending from a portion of the sheet. The sheet also has at least one slot for receiving the tab.

The sheet has at least one surface capable of receiving at least one kind or type of permanent ink. At least a portion of the surface has printing on it. The recyclable protective barrier is used for advertising as well as a barrier. The sheet is provided. Advertising is printed on at least one portion of the surface of the sheet using off-set printing and 4-color processing. The printed sheet is secured to at least one portion of an article by inserting the tab into the slot such that the advertising is visible and a physical barrier to the article is formed.

Additional objects and advantages of the invention will be set forth in part in the description which follows, and in part, will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1A depicts a recyclable protective barrier before placement on a portion of an article.

FIG. 1B depicts the recyclable protective barrier of FIG. 1A after it has been placed on a portion of an article.

FIG. 2A depicts a recyclable protective barrier applied to an amusement park ride seat and an amusement park ride safety bar.

FIG. 2B depicts the recyclable protective barrier of FIG. 2A prior to placement on an amusement park ride seat.

FIG. 2C depicts the recyclable protective barrier of FIG. 2A prior to placement on an amusement park ride safety bar.

FIG. 3A depicts an embodiment of the invention where the recyclable protective barrier is used to cover a portion of a public transportation seat.

FIG. 3B depicts a further embodiment of the invention where the recyclable protective barrier is used to cover a portion of a public transportation tray/table.

FIG. 4A depicts an embodiment of the invention where multiple recyclable protective barriers are used to cover a scooter.

FIG. 4B depicts an embodiment of the invention where multiple recyclable protective barriers are used to cover a stroller.

FIG. 5A depicts an embodiment of the invention where a recyclable protective barrier is used to cover a wheel chair.

FIG. 5B depicts an embodiment of the invention where a recyclable protective barrier is used to cover a bassinet.

FIG. 6 depicts an embodiment of the invention where a recyclable protective barrier is used to cover a basket.

### DETAILED DESCRIPTION OF THE PREFERRED EMBODIMENTS

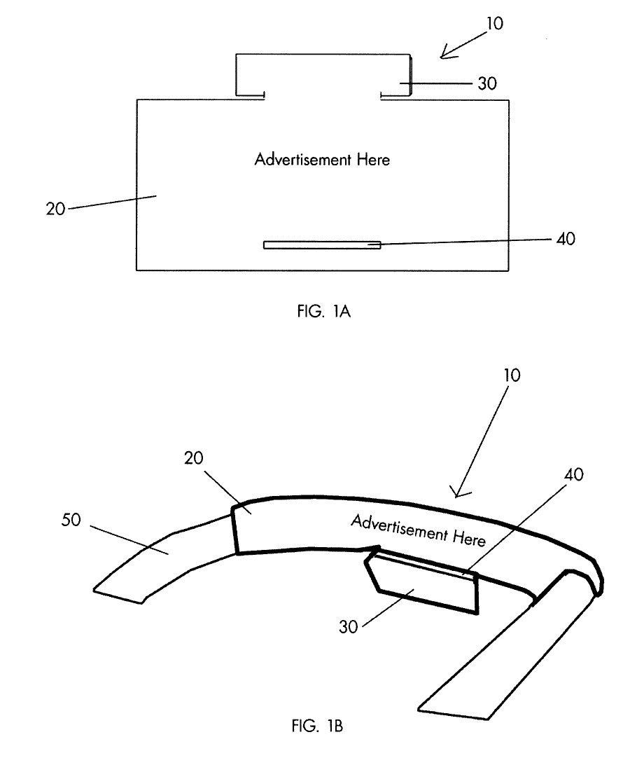

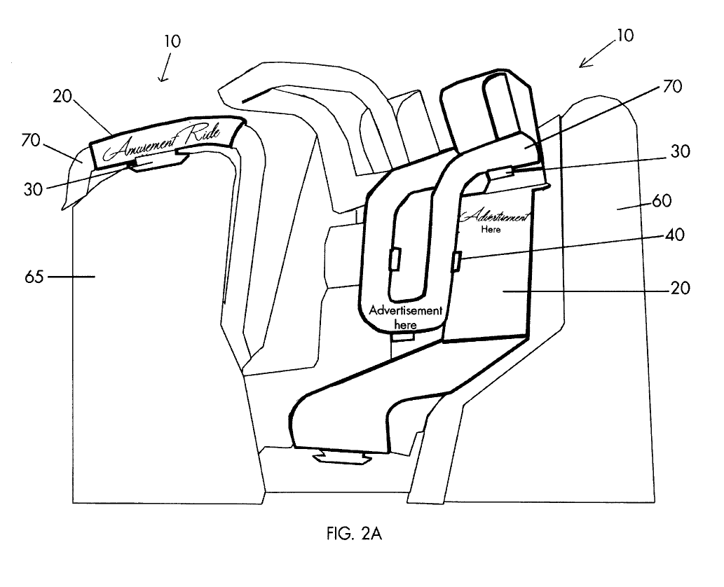

The present invention is a recyclable protective barrier that serves a dual purpose of forming a physical barrier between a person and at least one surface of an article and provides a medium for advertising. FIG. 1A depicts the simplest embodiment of the recyclable protective barrier prior to placement on a portion of an article (a handle bar as shown in FIG. 1B). In general, the recyclable protective barrier 10 comprises a single sheet of semi-rigid, recyclable, high density polyethylene fibrous web sheeting 20. This sheeting 20 is similar in strength and appearance to the sheeting used in the manufacture of overnight express mail envelopes. Because of the fibrous web structure, the sheeting 20 has high tear strength and/or is difficult to puncture or tear. In addition, the sheeting 20 is semi-rigid, meaning that it is flexible enough to be manipulated to cover an article and is capable of maintaining its shape once it has been positioned and secured over the article or a portion of the article. Moreover, the sheeting 20 is recyclable, meaning that the sheeting 20 is of a material that can be recycled using standard recycling processes. Any sheeting that has high tear strength and is puncture resistant is suitable for the present invention, provided that it is semi-rigid, recyclable, and formed from a high density polyethylene fibrous web. Preferably, the sheeting 20 is known commercially as TYVEK® and is sold by DuPont.

Since the sheeting 20 is both puncture and tear-resistant, it is necessary that the sheeting 20 be pre-cut to cover at least one surface of an article. Because of this requirement, the barrier 10 is formed from a single sheet of semi-rigid, recyclable, high density polyethylene fibrous web sheeting material 20. It has been found that the fibrous web structure of the sheeting 20 does not make it amenable to self-fabrication techniques such as pre-perforation and punching-out. Rather, the sheeting 20 must be pre-cut in the shape of the surface of the article to be covered. Cutting is achieved through any means known to one of ordinary skill in the art. Preferably, the sheeting 20 is pre-cut using a die and/or stamping process during manufacturing.

The sheeting 20 is cut to not only cover at least one surface of an article but to permit the sheeting 20 to be secured to at least one portion of an article. This is achieved by the sheeting 20 having at least one tab 30 extending from at least one portion of the sheeting 20. The sheeting 20 also has at least one slot 40 for receiving the tab 30. The shape of the tab 30 is designed so that the tab 30 extends around a portion of the article and outward through the slot 40 where the slot locks the tab 30 into place. FIG. 1B shows where a single tab and slot are used to secure the barrier in place over a handle bar (such as that for a stroller, shopping cart, shopping basket, bicycle, baby jogger, or, when two barriers are used, the grips of a walker or wheel chair). The barrier 10 comprises a single sheet 20, pre-cut to cover at least one surface of an article handle bar, such as that for a stroller or a shopping cart 50, having at least one tab 30 extending therefrom and at least one slot 40 for receiving the tab 30.

In order to use the barrier 10 for advertising, the sheet 20 must have at least one surface capable of receiving at least one kind of permanent ink. Since the barrier 10 is to serve as a barrier between the surface of an article and a person, the ink must be permanent and compatible with the surface of the sheet 20 so as not to come off on the skin of a person who may be in direct contact with the barrier 10. Therefore, water-based inks such as those used in screen-printing and ink jet printing, are not suitable for use in the present invention. It is not necessary that the entire surface of the sheet 20 contain printing. Rather, the printing may be placed on a portion of the surface of the sheet 20.

The present invention is suitable for serving as a barrier/advertising medium for any article known to one of ordinary skill in the art where it is desirous to provide a physical barrier to potential germ exposure. In particular, articles include but are not limited to: an amusement park ride seat, amusement park ride safety bar, a cart, a handle bar, a basket, a child restraint seat, a wagon, a wheel chair, a public transportation tray/table, a changing table, a pillow, a cushion, a seat, a public transportation seat, a stroller, a bassinet, a crib, a playpen, a highchair, a scooter, walker handle grips, and a mattress. Preferably the article is selected from the group consisting of: an amusement park ride seat, a basket, a handle bar, and a seat. It is well understood that more complex articles, such as a stroller or a cart, comprise combinations of articles such as a handle bar, a seat, and a basket. Further, when using these more complex articles, the user may want to cover only a portion, such as the handle bar, and not all portions of the article. Therefore, several barriers may be used to cover an article such as a cart. For example, a barrier may only be used on the handle bar. Alternatively, barriers may be found on the handle bar and over the basket. A single barrier may also cover two areas of an article, such as a seat and a handle bar. The design of the barrier is dictated by the article to be covered and by the manufacturing cost.

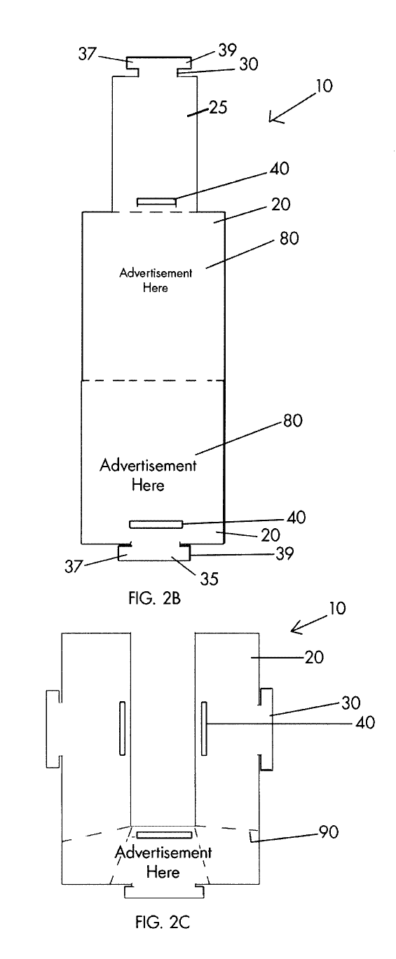

FIG. 2A depicts how the recyclable protective barrier 10 can be used in several different ways and combinations to cover an amusement park ride seat 60 and an amusement park ride safety bar 70. In use, the sheet 20 is secured to at least one portion of the article 60, 70 by inserting the tab 30 into the slot 40 such that the tab 30 extends through the slot 40 and is locked into place by the tab 30 edges extending beyond the length of the slot 40. FIG. 2A shows that a user may opt to cover only a portion of the ride safety bar 70 and not cover the seat 65 or total coverage may be desired such that the ride seat 60 is covered and the entire ride safety bar 70 is covered.

FIG. 2B depicts the recyclable protective barrier 10 for an amusement park ride seat when not in use. Semi-rigid, recyclable, high density polyethylene fibrous web sheeting is pre-cut to cover the seat surface of the amusement park ride as a single sheet 20. Tabs 30 are shown extending from one side of the sheet 20 but it is understood that the tabs 30 may extend from the opposite side or be alternating. In addition, it is understood that at least one tab is necessary and the number of tabs used is determined by the surface of the article to be covered. The tab 30 may be elongated to wrap around a portion of the article or a portion of the sheet 20 may wrap around the article to allow the tab 30 to be inserted into the slot 40. As shown, the tab 30 is elongated as it extends from the end of the sheet 25, where the opposite tab 35 is not elongated as it extends from the sheet 20. The tabs 30, 35 are depicted as a preferred embodiment where the tabs 30, 35 have laterally extended portions 37, 39 instead of being straight cut. The lateral extended portions 37, 39 keep the tabs from sliding back through the slots 40. In an alternate embodiment, the tab is elongated such that it not only extends through the slot but enough beyond the slot to remain in-place. Slots 40 are shown along a side opposite the tabs 30, 35. However, the tab and slot configuration may be any configuration that will enable the sheet 20 to be secured to at least one portion of the article by inserting a tab 30 into the slot 40. Printing 80 is shown along a portion of the surface of the sheet 20. The printing 80 is generally for advertising purposes and is, therefore, visible to the seat occupant.

FIG. 2C depicts an embodiment for a recyclable protective barrier 10 for an amusement park ride safety bar which surrounds a rider. The sheet 20 is shaped to cover the safety bar 70 (as shown in FIG. 2A). Tabs 30 are shown extending from one side of the sheet 20. Slots 40 are shown along a side opposite the tabs. In this embodiment, the portion of the sheet 20 with the tab 30 is wrapped around the safety bar (not shown) and the tab 30 is inserted into the slot 40 where the tab 30 is locked into place. FIG. 2C further shows a preferred embodiment where the sheet 20 is pre-scored 90 so the sheet 20 may be folded to better configure to the safety bar (not shown). FIG. 2A also shows an alternative embodiment to the recyclable protective barrier 10 for an amusement park ride safety bar 70 where only a portion of the safety bar is covered by the barrier 10. In that instance, the barrier 10 resembles that shown in FIG. 1A.

Referring back to FIG. 2A, once the barrier 10 is affixed to the amusement park ride seat 60, a person sitting in the amusement park ride seat 60 is protected from germs on the seat by the physical barrier created by the sheet 20 and is exposed to the advertising (printing) 80 on the sheet 20 at the same time. Similarly, when the barrier 10 is affixed to the amusement park ride safety bar 70, a person clasping the safety bar 70 is protected from germ exposure and the advertising (printing) 80 is visible to him.

As stated previously, the shape of the sheet is determined by the shape of the surface of the article to which the barrier is to be applied. Although most articles are easily covered by the general tab and slot configuration, there are instances where it may be necessary to score the sheeting to fit the article. The semi-rigid, recyclable, high density polyethylene fibrous web sheeting does not maintain a random fold. Therefore, scoring an area to be subjected to a fold enables a better fit of the barrier.

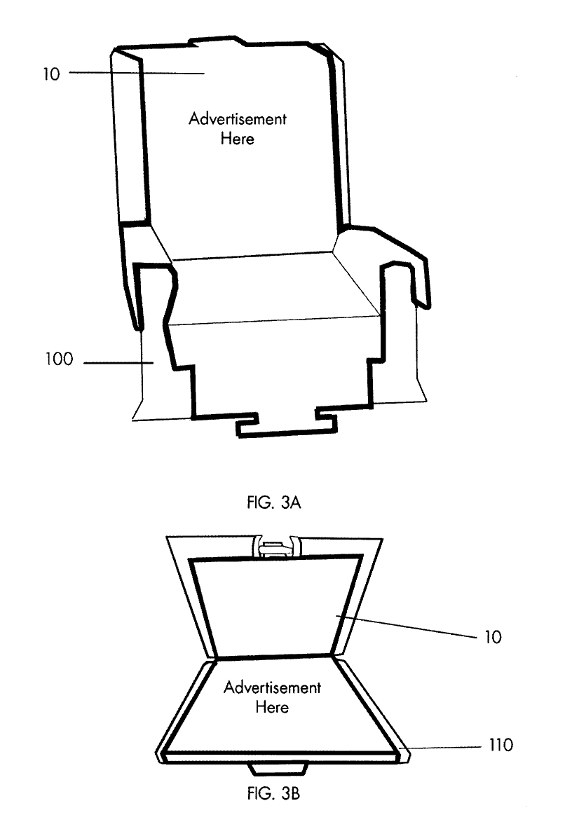

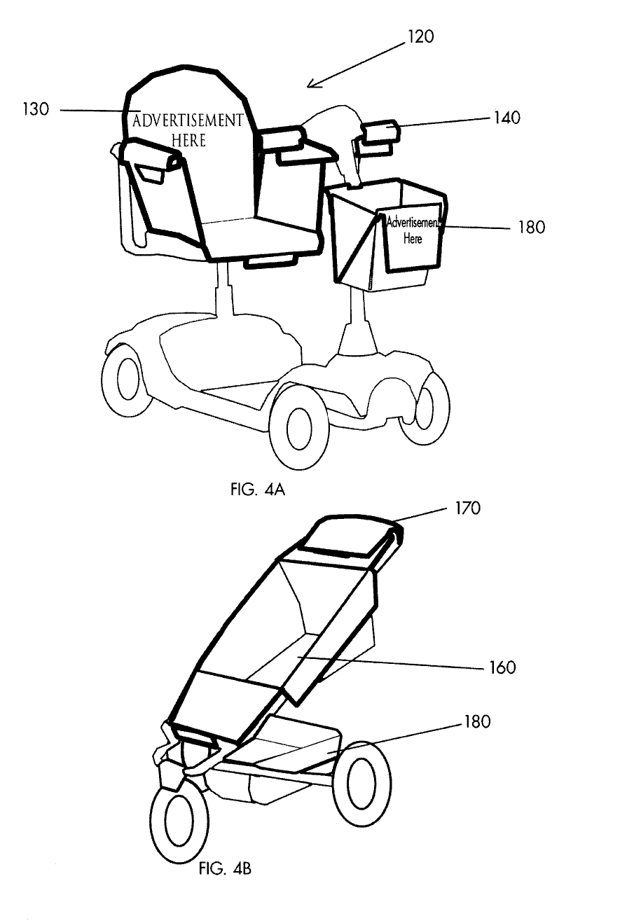

The barrier of the present invention is suitable for numerous applications. FIG. 3A depicts an embodiment where the barrier 10 is used to cover a portion of a public transportation seat 100. Although the seat shown is for an airline, it is understood that the barrier is suitable for any public transportation seat such as buses, trains, and boats. FIG. 3B depicts a further embodiment of the invention where the barrier 10 is used to cover a portion of a public transportation tray/table 110.

FIGS. 4A and 4B depict further recreational applications for the recyclable protective barrier. FIG. 4A shows how multiple barriers 10 are used to cover a scooter 120. In this embodiment, the scooter seat 130, handle bar (or grips) 140 and basket 150 are each covered by a barrier 10. FIG. 4B depicts how portions of a stroller are protected as a separate barrier is used to cover a stroller seat 160, a stroller handle bar 170, and a stroller basket 180. A similar configuration may be used to cover a cart which also has a handle bar, a seat, and a basket.

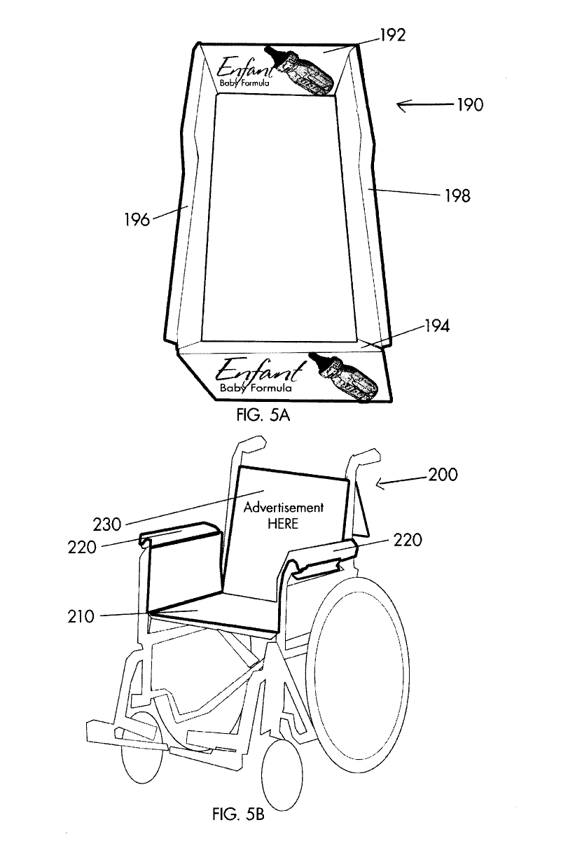

FIGS. 5A and 5B show how a single recyclable protective barrier is used to protect a bassinet 190 and a wheel chair 200. Although it is considered that these applications are typically found in hospitals, it is understood that similar devices may be found in homes or in nursing home facilities. In the case of the bassinet 190, the barrier is draped completely over the bassinet 90 but may only be tabbed at the head 192 and foot 194 portions of the bassinet 190 or alternatively at the left 196 and right sides 198 of the bassinet 190. Because the barrier is pre-scored, it is easily configured to the shape of the bassinet 190. Typically, a blanket and/or padding is placed on the bottom of the bassinet for a baby to lie upon. In the case of the wheel chair 200, the barrier is draped over the seat 210, arm rests 220, and back 230 portions of the chair 200 and secured to the chair at the arm rests 220. The barrier is pre-scored to easily conform to the shape of the wheel chair 200.

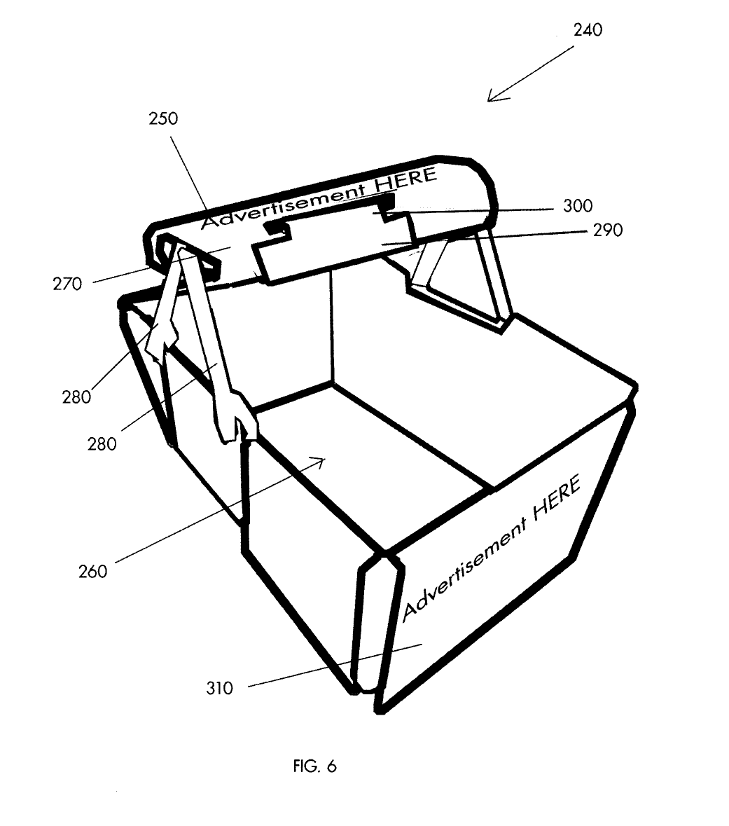

FIG. 6 shows how a single recyclable protective barrier is used to protect a shopping basket 240. In this configuration, the barrier 250 is pre-cut and pre-scored to fit the inner surface 260, such as the bottom and sides, of the basket 240. The barrier 250 is draped over the sides of the shopping basket 240. The barrier 250 is cut so that a portion of the barrier 250 is elongated at one end of the basket 270 so it can be extended up and around the handles 280 of the basket 240. The barrier 250 is secured in place by inserting a tab 290 through a slot 300. Because the basket 240 has many surfaces, advertising may be placed on a portion of the barrier 250 that covers either an inner surface 260, an outer surface 310, and/or on the portion of the barrier that covers the handles 280. Although the basket shown is hand-held, it is understood that the configuration described herein is applicable to a larger shopping basket such as that found on a cart.

The tab and slot assembly of the barrier enables easy assembly without the need for fasteners. However, in some instances, it may be desirable to have fasteners to provide additional hold. Any fastener known to one of ordinary skill in the art is suitable. In particular, an adhesive may be affixed to at least one surface of the sheet and the adhesive portion of the sheet is stuck directly on to the article. Alternatively, the adhesive may be applied to the tabs to hold the tabs in place after insertion through the slot. The adhesive may be a pressure sensitive adhesive, a tape, a paste and glue.

The recyclable protective barrier may be dispensed using a dispenser designed to accommodate the size and shape of the barrier. Such dispensers may be wall mountable or table-top models. The barrier is dispensed as an individual unit, similar to that of paper towels which come in sheet form.

After use, the protective barrier is easily removed by disengaging the tabs from the slots. The barrier is easily recycled using known recycling techniques. Hence, the protective barrier may be recycled by merely placing the barrier into a bin provided to the public.

The protective barrier is a suitable medium for advertising because of the semi-rigid structure of the barrier material. Advertising is printed on at least one portion of a surface of the sheet which is capable of receiving at least one kind of permanent ink. The printing technique used is off-set printing and 4-color processing. These processing techniques enable the ink to set permanently and properly so as not to come off on the skin of someone who may come into contact with the barrier.

The protective barrier of the present invention thus satisfies the need for protection from the spreading of germs and disease, is environmentally friendly because it is recyclable, and allows advertisers to share information about their products with the general public.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

What is claimed is:

1. A recyclable protective barrier comprising:
a single sheet of semi-rigid, recyclable, high density polyethylene fibrous web sheeting pre-cut to cover at least one surface of an article;
the sheet having at least one tab extending therefrom and at least one slot for receiving the tab;
wherein the sheet has at least one surface capable of receiving at least one kind of permanent ink;
wherein at least a portion of the surface capable of receiving at least one kind of permanent ink has printing thereon; and
wherein the sheet is secured to at least one portion of the article by inserting the tab into the slot, forming a physical barrier between at least one portion of the article and a person and wherein the printing is visible to the person.

2. A recyclable protective barrier according to claim 1, wherein the article is selected from the group consisting of: an amusement park ride seat, an amusement park ride safety bar, a cart, a handle bar, a basket, a child restraint seat, a wagon, a wheel chair, a public transportation seat, a public transportation tray/table, a changing table, a pillow, a cushion, a seat, a stroller, a bassinet, a crib, a playpen, a highchair, a scooter, walker handle grips, and a mattress.

3. A recyclable protective barrier according to claim 2, wherein the article is a basket.

4. A recyclable protective barrier according to claim 2, wherein the article is an amusement park ride seat.

5. A recyclable protective barrier according to claim 2, wherein the article is a handle bar.

6. A recyclable protective barrier according to claim 2, wherein the article is a seat.

7. A recyclable protective barrier according to claim 1, wherein the article comprises a seat, a handle bar, and a basket.

8. A recyclable protective barrier according to claim 1, wherein the single sheet of semi-rigid, recyclable, high density polyethylene fibrous web sheeting is scored to fit the article.

9. A recyclable protective barrier according to claim 8, wherein the single sheet of semi-rigid, recyclable, high density polyethylene fibrous web sheeting is die-cut.

10. A recyclable protective barrier according to claim 1, further comprising an adhesive affixed to at least one surface of the sheet.

11. A recyclable protective barrier according to claim 1, wherein the permanent ink is an ink used in off-set printing 4-color processing.

12. A recyclable protective barrier according to claim 11, wherein the sheet is printed on a top surface and a bottom surface.

13. A recyclable protective barrier according to claim 1, wherein the recyclable protective barrier is dispensed from a dispenser.

14. A method for advertising comprising:
a) providing a recyclable protective barrier comprising: a single sheet of semi-rigid, recyclable, high density polyethylene fiber sheeting pre-cut to cover at least one surface of an article; the sheet having at least one tab extending therefrom and at least one slot for receiving the tab wherein the sheet has at least one surface capable of receiving at least one kind of permanent ink;
b) printing advertising on at least one portion of the surface of the sheet using off-set printing and 4-color processing; and
c) securing the sheet to the article by inserting the tab into the slot wherein a physical barrier is formed between the covered surface of the article and a person and wherein the advertising is visible to the person.

15. A method according to claim 14, wherein the article is selected from the group consisting of: an amusement park ride seat, an amusement park ride safety bar, a cart, a handle bar, a basket, a child restraint seat, a wagon, a wheel chair, a public transportation seat, a public transportation tray/table, a changing table, a pillow, a cushion, a seat, a stroller, a bassinet, a crib, a playpen, a highchair, a scooter, walker handle grips, and a mattress.

16. A method according to claim 15, wherein the article a basket.

17. A method according to claim 15, wherein the article is an amusement park ride seat.

18. A method according to claim 15, wherein the article is a handle bar.

19. A method according to claim 15, wherein the article is a seat.

20. A method according to claim 14, wherein the article comprises a seat, a handle bar, and a basket.

21. A method according to claim 14, wherein the sheet is printed on at least one portion of a top surface and at least one portion of a bottom surface of the sheet.

22. A method according to claim 14, wherein a plurality of recyclable protective barriers is provided for an article and wherein each barrier covers a portion of the article.

23. A method according to claim 22, wherein the recyclable protective barriers cover a handle bar and a basket.

24. A method according to claim 23, further comprising a recyclable protective barrier for covering a seat.
